(19) United States
(12) Patent Application Publication
(10) Pub. No.: US 2026/0154802 A1
(43) Pub. Date: Jun. 4, 2026

(54) Vision Inspection Method For Pin Type Parts

(71) Applicant: ENSCAPE CO., LTD., Yongin-si (KR)

(72) Inventors: Hyeok Gi GWON, Yongin-si (KR); Ji Man RYU, Suwon-si (KR); Sang Jin CHOI, Seongnam-si (KR); Seong Gi KIM, Asan-si (KR); In Ho KA, Seongnam-si (KR)

(21) Appl. No.: 19/378,957

(22) Filed: Nov. 4, 2025

(30) Foreign Application Priority Data
Nov. 5, 2024 (KR) 10-2024-0155253
Mar. 4, 2025 (KR) 10-2025-0027545

(51) Int. Cl. G06T 7/00

(52) U.S. Cl. CPC G06T 7/0004; G06T 2207/20021; G06T 2207/20221; G06T 2207/30164

(57) ABSTRACT

Disclosed is a vision inspection method for pin-type component, the method including seating a pin-type component on an upper surface of an inspection stage in a tilted posture; correcting the pin-type component to an upright posture based on a magnet; capturing an image of a surface of the pin-type component while rotating the pin-type component; and performing defect inspection on the pin-type component based on a plurality of captured images acquired by capturing the surface of the pin-type component.

### CROSS REFERENCE TO RELATED APPLICATION

Priority to Korean Patent Applications No. 10-2024-0155253 filed on Nov. 5, 2024 and No. 10-2025-0027545 filed on Mar. 4, 2025, the entire disclosures of which are incorporated by reference herein, is claimed.

### BACKGROUND OF THE INVENTION

### Field of the Invention

The disclosure relates to a vision inspection method for pin-type component. In addition, the present application is the result of “Scale-up Technology Commercialization Program” supervised by the Korea Institute for Advancement of Technology (KIAT) (Project title: Development of Pogo Pin Vision Inspection Equipment Based on a Reconfigurable Production System and Mass Production Verification at Client Companies, and Project No.: P0023213).

### Description of the Related Art

With development of artificial intelligence (AI), Internet of things (IoT), big data, etc. the transition to a data economy is rapidly increasing a demand for semiconductors in various industrial fields such as autonomous vehicles, robots, 5G wireless communication, and mobile home appliances. In a semiconductor process, pogo pins are required as a key component for testing the performance and reliability of a semiconductor. In connection with the pogo pins, Korean Patent No. 1204273 has been disclosed.

The pogo pins are produced in various specifications to have a minimum diameter of about 0.15 mm and a minimum length of 1 mm. At present, the appearance of the pogo pin has been inspected with the naked eyes using a microscope, and classification work has also been carried out manually, thereby resulting in low production efficiency.

To address such conventional issues, an automated method for performing vision inspection of pogo pins is required. In addition, it is necessary to provide a means for holding the pogo pin in an appropriate position during the vision inspection.

An aspect of the disclosure is to provide a method of automating vision inspection of pogo pins.

Another aspect of the disclosure is to provide a vision inspection method with improved precision and reliability for inspecting the side surface of a pogo pin having a curved shape.

The problems of the disclosure are not limited to the aforementioned problems, and other problems not mentioned above may become apparent to those skilled in the art from the following description.

### SUMMARY OF THE INVENTION

According to an embodiment of the disclosure, an vision inspection method for pin-type component includes: seating a pin-type component on an upper surface of an inspection stage in a tilted posture; correcting the pin-type component to an upright posture based on a magnet; capturing an image of a surface of the pin-type component while rotating the pin-type component; and performing defect inspection on the pin-type component based on a plurality of captured images acquired by capturing the surface of the pin-type component.

In the correcting the pin-type component to the upright posture, the magnet may move relative to the pin-type component so that the pin-type component can be corrected to the upright posture.

In the correcting the pin-type component to the upright posture, a magnet driving unit may be controlled by a proportional integral (PI) control method to move the magnet so that a central axis of the magnet and a central axis of the pin-type component can become coaxial.

In the correcting the pin-type component to the upright posture, a distance M to move the magnet located below the inspection stage toward the pin-type component in a horizontal direction may be calculated by an equation M=KX, where K is a proportional constant obtained experimentally, and X is the length of the pin-type component projected on the upper surface of the inspection stage.

In the capturing the image of the surface of the pin-type component, the position of the inspection stage relative to a rotation driving unit which rotates the inspection stage may be adjusted so that a central axis of the pin-type component can be aligned with a rotation axis of the rotation driving unit.

The performing the defect inspection may include: acquiring a plurality of corrected images in which the pin-type component shown in the captured images is changed to predetermined posture; acquiring a merged image by extracting extraction target areas, in which a portion of the pin-type component appears, from the corrected images, and connecting the plurality of extraction target areas; and performing a vision inspection on the merged image.

In the capturing the image of the surface of the pin-type component, the surface of the pin-type component may be captured while a lighting module is irradiating light to the pin-type component.

In the acquiring the merged image, the extraction target area may be identified based on difference in pixel values between the surface of the pin-type component and the background in the corrected image, which is caused by light from the lighting module.
the acquiring the corrected image may include: distinguishing a plurality of regions of interest for the pin-type component appearing in the captured images; acquiring a plurality of divided images by dividing the captured images so that the plurality of regions of interest can appear in different images; and acquiring plurality of the corrected images in which the regions of interest appearing in the divided images are changed to the predetermined posture.

In the acquiring the merged image, the merged image may be acquired as the plurality of extraction target areas are sequentially connected corresponding to actual positions of the pin-type component.

In the acquiring the corrected image, the predetermined posture may be a posture in which the pin-type component is captured upon being exactly vertical relative to the inspection stage.

Other details of the disclosure are included in the detailed description and the accompanying drawings.

### BRIEF DESCRIPTION OF THE DRAWINGS

FIG. 1 is a schematic view illustrating a pin-type component that can be inspected by a vision inspection method according to an embodiment of the disclosure.

FIG. 2 is an exemplary perspective view of a non-contact alignment device usable in a vision inspection method for pin-type component according to an embodiment of the disclosure.

FIG. 3 is an exploded perspective view of the non-contact alignment device shown in FIG. 2.

FIG. 4 is a flowchart of a vision inspection method for pin-type component according to an embodiment of the disclosure.

FIG. 5 is a diagram for illustrating the principle of adjusting a pin-type component by using a magnet according to the disclosure.

FIG. 6 is a view showing a state in which a pin-type component is placed on an inspection stage in a tilted posture.

FIG. 7 is a view showing a state in which a pin-type component is corrected to an upright posture by movement of a magnet.

FIG. 8 is a diagram for illustrating how to determine a horizontal movement distance of a magnet according to an embodiment of the disclosure.

FIG. 9 is a view showing the adjustment of an X-axis error of an inspection stage by a non-contact alignment device according to an embodiment of the disclosure.

FIG. 10 is a view showing the adjustment of a Y-axis error of an inspection stage by a non-contact alignment device according to an embodiment of the disclosure.

FIG. 11 is a view showing the operation of a rotation driving unit of a non-contact alignment device according to an embodiment of the disclosure.

FIG. 12 is a flowchart of performing defect inspection on a pin-type component according to an embodiment of the disclosure.

FIG. 13 is a flowchart of acquiring a plurality of corrected images based on captured images according to an embodiment of the disclosure.

FIG. 14 is a view showing the acquisition of a corrected image based on any one of divided images.

FIG. 15 is a view showing the identification of an extraction target area in the corrected image of FIG. 14, and the formation of a merged image based on the extraction target area.

### DETAILED DESCRIPTION OF THE INVENTION

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, upper/lower/left/right/front/rear directions mentioned below are merely used to describe the disclosure with respect to a specific reference point, and the disclosure is not construed as being limited to such directions. In other words, it is apparent that, in actual use, the installation and use may be achieved in directions different from those set forth herein, and the disclosure should be interpreted as including such embodiments.

Meanwhile, the term “pin-type component” mentioned below may refer to a component shaped like a long pin. Furthermore, the pin-type component may include a magnetic material that is magnetized in a magnetic field. For example, the pin-type component may be a pogo pin.

Below, a vision inspection method for pin-type component according to an embodiment of the disclosure will be described with reference to the accompanying drawings.

Prior to describing the vision inspection method for pin-type component according to an embodiment of the disclosure, a pin-type component to be inspected and a device usable to perform the vision inspection method for the pin-type components according to an embodiment of the disclosure will be described.

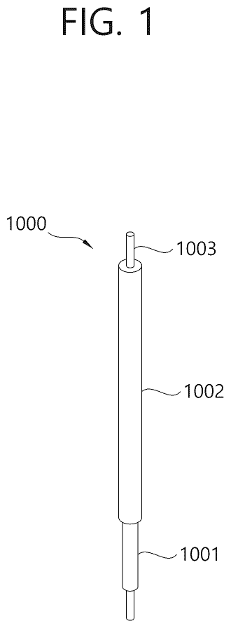

FIG. 1 is a schematic view illustrating a pin-type component that can be inspected by a vision inspection method according to an embodiment of the disclosure.

As shown in FIG. 1, the pin-type component may be a pogo pin. The pogo pin 1000 is generally configured in the form of a cylinder, and thus vision inspection is required for the curved side surface as well as the top and bottom surfaces. In particular, the curved side surface requires the rotation of the pogo pin 1000 by 360 degrees during the vision inspection.

The pogo pin 1000 may be divided into a lower portion 1001, a middle portion 1002, and an upper portion 1003. The lower portion 1001, the middle portion 1002, and the upper portion 1003 may each have an approximately cylindrical shape. The lower portion 1001 has a smaller diameter than the middle portion 1002, and may extend with a shorter length (in the height direction) than the middle portion 1002. In the pogo pin 1000, the middle portion 1002 may have the largest diameter and the longest length. The upper portion 1003 has a relatively short diameter and may also have the shortest length in the pogo pin 1000. However, the shape of the pogo pin 1000 is not necessarily limited to this example.

To inspect the appearance of the pogo pin 1000, a vision camera module may be used. When the pogo pin 1000 is rotated for side-surface inspection, two conditions need to be satisfied to maximize the accuracy of the vision inspection. First, the pogo pin 1000 needs to be erect vertically; and second, the central axis of the pogo pin 1000 needs to be coaxial with the rotational central axis around which the pogo pin 1000 rotates.

To satisfy the aforementioned two conditions, mechanical alignment may be considered, but the outer surface may be obscured by an alignment mechanism (e.g., a gripper). In particular, when the size of the pogo pin 1000 is small, the portion of the outer surface obscured by the gripper may increase. In addition, when the end of the alignment mechanism is made sharp to minimize the obscured portion of the outer surface of the pogo pin 1000, stress concentration may cause damage to the pogo pin 1000.

Therefore, the method according to an embodiment of the disclosure employs a device capable of changing and aligning the posture of the pogo pin 1000 in a non-contact manner. Meanwhile, the following description will be made on the assumption that the pin-type components 1000 according to the disclosure are ‘pogo pins.’ However, the disclosure is not limited to the pogo pins, and any magnetic and elongated pin-type components may be applicable without limitation.

Furthermore, the method according to an embodiment of the disclosure will be described below on the premise that the pogo pin is aligned and rotated, and then imaged to undergo inspection of the side and upper surfaces.

To this end, the method according to an embodiment of the disclosure may employ a non-contact posture alignment device, a vision camera module, a lighting module, and an information processing device.

The non-contact posture alignment device may be provided to align the posture of the pin-type components based on a magnet. Specifically, the non-contact posture alignment device may include an inspection stage on which the pin-type component is placed and maintains its posture at the placement, a magnet movable relative to the inspection stage, and a rotation driving unit used for rotating the inspection stage and movable relative to the inspection stage. In this case, the components of the non-contact posture alignment device may be implemented in various ways using conventionally known techniques.

The vision camera module may be at least one selected from among various conventional camera modules used for vision inspection.

The lighting module may include various types of conventionally known lights to implement the method. For example, the lighting module may include a coaxial lighting module installed coaxially with the vision camera module, and a backlight module configured to form a background of the inspection stage.

Meanwhile, the information processing device may be configured as a conventionally known computing device to control the non-contact posture alignment device, the vision camera module, and the lighting module. In addition, the information processing device may be configured to communicate with the vision camera module, receive an image captured by the vision camera module, and perform defect inspection based on the image. In this case, conventionally known algorithms or programs may be utilized for the defect inspection, and such algorithms or programs may be non-transitorily recorded in the information processing device.

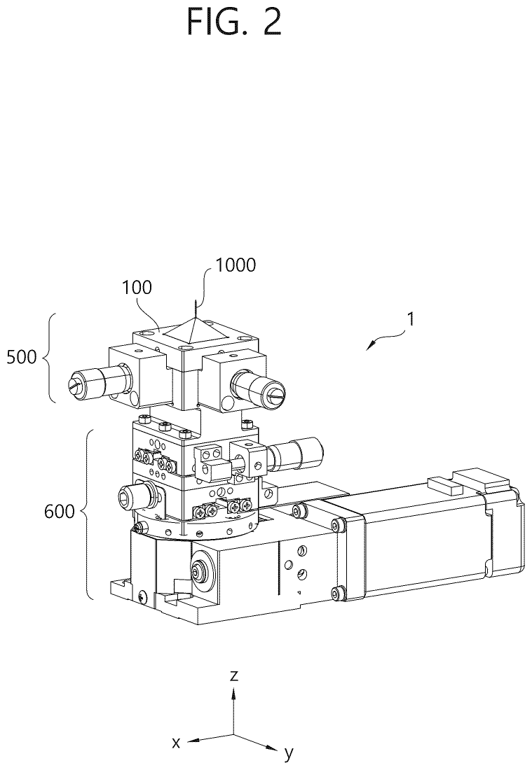

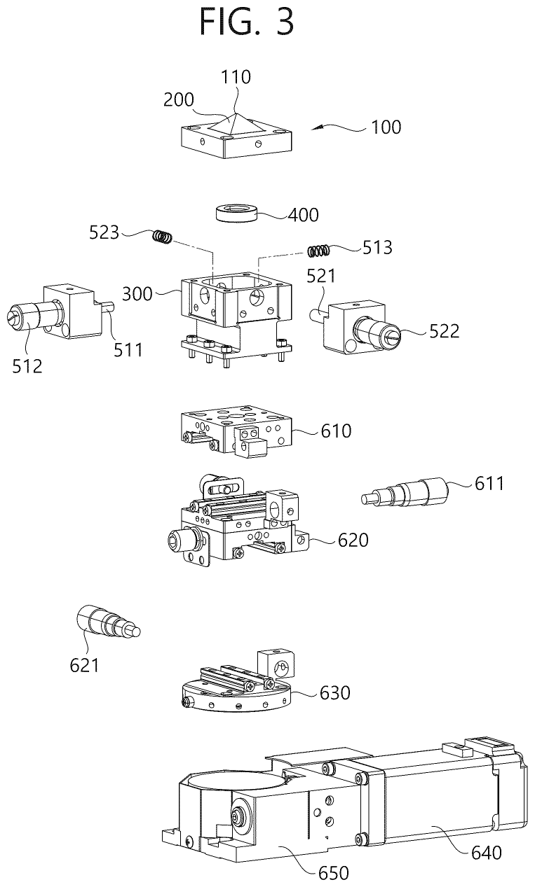

Below, an example of the non-contact alignment device usable in the method according to an embodiment of the disclosure will be described with reference to FIGS. 2 and 3. FIG. 2 is an exemplary perspective view of a non-contact alignment device usable in a vision inspection method for pin-type component according to an embodiment of the disclosure. In this regard, FIG. 3 is an exploded perspective view of the non-contact alignment device shown in FIG. 2.

Referring to FIGS. 2 and 3, the non-contact alignment device 1 according to an embodiment of the disclosure may include a seating unit 100, a body unit 300, a magnet 400, a position adjustment unit 500, a position alignment unit 600, and a rotation driving unit 640.

The seating unit 100 may be configured so that the pogo pin 1000 can be seated on its upper surface. In the vision inspection method for pin-type component according to an embodiment of the disclosure, the seating unit 100 serves as an inspection stage. The upper surface of the seating unit 100 may be provided with a seating surface 110 configured to prevent the pogo pin 1000 seated thereon from slipping. For example, the seating surface 110 may have a high coefficient of friction or a concave groove capable of accommodating an end of the pogo pin 1000. The pogo pin 1000 seated on the seating unit 100 may maintain its posture by the magnet 400 (to be described later) while its lower end portion is in contact with the seating unit 100. When seated on the seating surface 110, the pogo pin 1000 may be vertically erect or may be slightly tilted.

A recognition unit 200 may be provided around the seating surface 110 of the seating unit 100. The recognition unit 200 may be configured in a predetermined geometric shape. For example, the recognition unit 200 may have a polygonal shape. The recognition unit 200 may have corners so as to be easily recognized in an image captured from above in the vertical direction or from the side by the vision camera module. Therefore, the recognition unit 200 can be easily excluded from the image captured by the vision camera module during the vision inspection. In other words, the recognition unit 200 allows the areas corresponding to the seating unit 100 and the pogo pin 1000 in the image to be easily identified.

The body unit 300 is coupled to the lower side of the seating unit 100, while forming an internal space where the magnet 400 (to be described later) will be placed. The internal space of the body unit 300 may be large enough to allow the magnet 400 to move a predetermined distance in the horizontal direction. The bottom surface of the body unit 300 may be coupled to a first frame 610 located at the uppermost side of the position alignment unit 600.

The magnet 400 is configured to correct the posture of the pogo pin 1000. The magnet 400 may be placed inside the body unit 300 so as to be initially positioned vertically below the seating unit 100. The magnet 400 may have a magnetic force sufficiently strong to affect the pogo pin 1000 seated on the upper side of the recognition unit 200. The magnet 400 may for example be shaped like a disc, with the upper and lower portions having different polarities.

A magnet holder (not shown) may be configured so that its central portion can be coupled to the magnet 400 and it can move within the body unit 300 in the horizontal direction. In this case, the upper end of the magnet holder (not shown) may be in close contact with the ceiling of the internal space of the body unit 300, and may be slidable along the inner wall of the body unit 300.

The position adjustment unit 500 may be configured to adjust the horizontal position of the magnet 400. Here, the horizontal direction may refer to a direction in which the magnet 400 slides in any direction with respect to a flat bottom of the internal space of the body unit 300. To help understanding, if the bottom of the internal space of the body unit 300 corresponds to an XY plane, the horizontal direction may be represented by a vector on the XY plane. When the horizontal position of the magnet 400 is changed by the position adjustment unit 500, the magnetic field may vary. As a result, the direction of the magnetic force acting on the pogo pin 1000 may change, thereby adjusting the posture of the pogo pin 1000. Meanwhile, as described above, when the posture (or angle) of the pogo pin 1000 is adjusted by changing the horizontal position of the magnet 400, the lower end portion of the pogo pin 1000 can remain in contact with the seating unit 100 without slipping.

The position adjustment unit 500 may include a first position adjustment unit 511 configured to adjust the position of the magnet 400 within the body unit 300 in the X-axis direction, and a second position adjustment unit 521 configured to adjust that position in the Y-axis direction. The first position adjustment unit 511 is arranged to extend across the X-axis direction on the side wall of the body unit 300, and has an end portion to support the magnet 400 or the magnet holder. In this case, the position of the first position adjustment unit 511 may be adjusted in the X-axis direction by a first position adjustment driving unit 512.

The length of the first position adjustment unit 511 inserted into the body unit 300 may be adjustable. In this case, the position of the magnet 400 in the X-axis direction may vary depending on the insertion length of the first position adjustment unit 511 into the body unit 300. Meanwhile, a first elastic member 513 may be provided opposite the first position adjustment unit 511 with the magnet 400 therebetween. The first elastic member 513 may be configured to exert a force on the magnet 400 toward the first position adjustment unit 511. Therefore, the magnet 400 is pressed against the end portion of the first position adjustment unit 511 by the first elastic member 513. As a result, the position of the magnet 400 in the X-axis direction may be adjusted according to the insertion length of the first position adjustment unit 511, and may be moved along with the first position adjustment unit 511 by the elastic force when the first position adjustment unit 511 is retracted.

The second position adjustment unit 521 is configured to press the magnet 400 along the Y-axis direction. The second position adjustment unit 521 may be configured similarly to the first position adjustment unit 511 and may be oriented perpendicularly to the first position adjustment unit 511. The protruding length of the second position adjustment unit 521 in the Y-axis direction may be adjusted by a second position adjustment driving unit 522. A second elastic member 523 may be provided opposite the second position adjustment unit 521 with the magnet 400 therebetween. The second elastic member 523 functions similarly to the first elastic member 513 except that it exerts a force in the Y-axis direction.

In the foregoing description, the first position adjustment unit 511, the second position adjustment unit 521, the first elastic member 513 and the second elastic member 523 are in direct contact with the magnet 400 to exert the force or to change the position, but their configuration may be modified to be in contact with the magnet holder (not shown) to exert the force.

The position alignment unit 600 may be configured to align the central axis of the pogo pin 1000 with the rotation axis of the inspection stage after the pogo pin 1000 is vertically erected by the position adjustment unit 500. The pogo pin 1000 is tiny and may be slightly misaligned with the center of the seating unit 100 when it is seated on the seating unit 100. In addition, when the angle of the pogo pin 1000 is adjusted by the magnet 400, the pogo pin 1000 may slip slightly or the contact position may change on the upper surface of the seating unit 100 after being rotated according to the shape of the lower end of the pogo pin 1000. In other words, it is difficult to maintain a constant position each time when the pogo pin 1000 is seated, and the position may also change even when the posture is corrected. In this case, when the inspection stage rotates around a fixed rotation axis, the pogo pin 1000 may revolve around that rotation axis. When the pogo pin 1000 moves in a circular motion, it becomes difficult to obtain an accurate inspection image, and the accuracy of the inspection may also be decreased. To solve these problems, the position alignment unit 600 is configured to horizontally move the body unit 300 so that the central axis of the seated pogo pin 1000 can be aligned with the rotation axis.

The position alignment unit 600 may include a first frame 610, a first frame driving unit 611, a second frame 620, a second frame driving unit 621, a third frame 630, a base 650, and a rotation driving unit 640.

The first frame 610 may be configured to move relative to the second frame 620 in the X-axis direction. The upper portion of the first frame 610 may be coupled to the lower portion of the body unit 300. The first frame 610 may be connected to the second frame 620 by a moving direction constraint means, for example, a linear guide, so that the first frame 610 can move only in the X-axis direction. The first frame driving unit 611 is installed in the X-axis direction and configured to adjust the position of the first frame 610 on the second frame 620 along the X-axis direction.

The second frame 620 may be configured to move relative to the third frame 630 in the Y-axis direction. The second frame 620 may be connected to the third frame 630 by a moving direction constraint means, for example, a linear guide. The second frame driving unit 621 may be configured to adjust the position of the second frame 620 along the Y-axis direction.

The third frame 630 may be configured to rotate relative to the base 650 of the rotation driving unit 640. The rotation driving unit 640 may generate a driving force to rotate the third frame 630. For example, a coupling member for rotating the third frame 630 may be positioned on the upper surface of the base 650. The coupling member may be configured to rotate on the upper surface of the base 650 by the power of the rotation driving unit 640 and may be coupled to the lower surface of the third frame 630. Meanwhile, the lower portion of the base 650 may be coupled to an external structure. In this case, the order of the first frame 610 and the second frame 620 described above may be reversed.

The first frame 610, the first frame driving unit 611, the second frame 620, and the second frame driving unit 621 are configured to rotate together with the third frame 630. Therefore, when the positions of the body unit 300 in the X-axis and Y-axis directions are adjusted by the first frame 610 and the second frame 620, the rotational radius of the pogo pin 1000 is also adjustable. Consequently, the non-contact alignment device 1 may adjust the positions of the rotation axis thereof in the X-axis and Y-axis directions with respect to the pogo pin 1000. Accordingly, the non-contact alignment device 1 may ultimately align the rotation axis of the first frame 610 coaxially with the central axis of the pogo pin 1000.

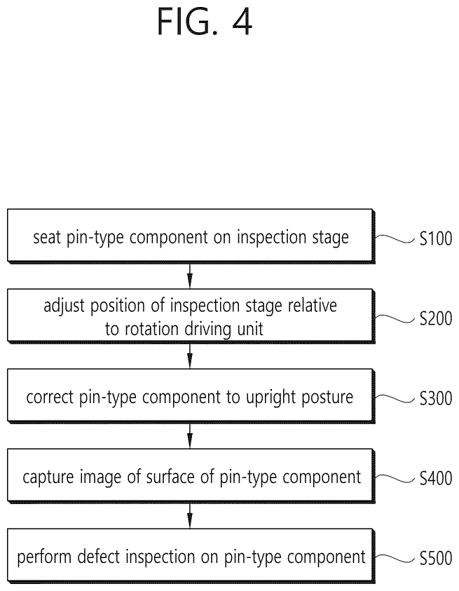

Below, the vision inspection method for pin-type component according to an embodiment of the disclosure will be described with reference to the foregoing description and FIGS. 4 to 15. FIG. 4 is a flowchart of the vision inspection method for pin-type component according to an embodiment of the disclosure.

As shown in FIG. 4, the vision inspection method for pin-type component according to an embodiment of the disclosure may include the steps of seating the pin-type component on the inspection stage (S100), adjusting the position of the inspection stage relative to the rotation driving unit (S200), correcting the pin-type component to an upright posture (S300), capturing an image of the surface of the pin-type component (S400), and performing defect inspection on the pin-type component (S500).

In Step S100 where the pin-type component is seated on the inspection stage, a gripper or a transfer device capable of picking up and placing the pin-type component like the gripper may place the pin-type component on the inspection stage. In this case, the inspection stage may be implemented by various devices or members capable of supporting the pin-type component placed by the transfer device. In this case, the seating unit plays such a role in the foregoing example of the non-contact alignment device.

In Step S200 where the position of the inspection stage relative to the rotation driving unit is adjusted, the position of the inspection stage may be adjusted so that the lower portion of the pin-type component can be positioned on the rotation axis of the rotation driving unit for rotating the inspection stage. To this end, the inspection stage may be adjustable in position relative to the rotation driving unit. For example, the position of the inspection stage may be adjustable in the X-axis and Y-axis directions with respect to the rotation driving unit, like the seating unit of the non-contact alignment device described above.

Once Step S200 is completed, the lower portion of the pin-type component is positioned on or adjacent to the rotation axis of the rotation driving unit. Therefore, upon the completion of Step S200, the contact point between the pin-type component and the inspection stage can be positioned on or adjacent to the rotation axis of the rotation driving unit.

In Step S200, the current position of the pin-type component may be identified using the backlight module and the vision camera module. For example, in Step S200, the current position of the pin-type component may be identified based on a position check image captured from the side of the pin-type component while the backlight module located behind the pin-type component is illuminated. In this case, the light from the backlight module causes the pin-type component to be darkly expressed in the position check image, so that the silhouette of the pin-type component can appear clearly.

The information processing device may receive the position check image and determine the position and/or coordinates of the contact point or lower end of the pin-type component. For example, the current positions of the inspection stage and the rotational axis of the rotation driving unit may be accurately identified based on control information about the device. Therefore, if only the position of the pin-type component on the inspection stage is identified based on the position check image, the current position of the pin-type component as well as a displacement required to move the inspection stage so as to position the contact point of the pin-type component on the rotational axis may be identified.

In this case, in order to determine both the X-axis and Y-axis displacements of the inspection stage, the position check image may include an X-axis displacement image for determining the X-axis displacement and a Y-axis displacement image for determining the Y-axis displacement. The two images may be captured by the vision camera modules arranged to face the inspection stage in directions perpendicular to each other. Alternatively, the two images may be captured by a single vision camera module, but the inspection stage may be rotated 90 degrees between capturing the first and second images.

In Step S300 where the pin-type component is corrected to the upright posture, the magnet may be used to correct the pin-type component to the upright posture. In this case, the upright posture may refer to a posture in which the central axis of the pin-type component forms an approximately vertical angle to the inspection stage. The transfer device may transfer the pin-type component onto the inspection stage in a posture as close to the upright posture as possible. However, seating the pin-type components on the inspection stage in an exactly vertical posture from the beginning not only increase difficulty of controlling the transfer device but also takes a long time. In addition, even though the inspection stage holds the lower portion of the pin-type component by magnetic force or other known methods, slight vibrations may be transmitted to the pin-type component due to the movement of the inspection stage in the previous Step S200. As a result of such vibrations, the posture of the pin-type component may be tilted even though the pin-type component is initially loaded vertically on the inspection stage.

According to the disclosure, the transfer device places the pin-type component in a tilted posture in Step S100 where the pin-type component is seated on the inspection stage, so that the pin-type component can be loaded onto the inspection stage within a short period of time. Thereafter, in Step S300, the magnet located below the inspection stage moves relative to the pin-type component, thereby correcting the pin-type component to the upright posture.

Therefore, according to the disclosure, the pin-type component in the upright posture can be quickly prepared on the inspection stage, and damage to the pin-type component while erecting the pin-type component vertically can be minimized.

Meanwhile, in Step S400 where the images of the surface of the pin-type component are captured, the vision camera module may initiate capturing the images while the pin-type component is rotating. To this end, the vision camera module may be prepared to face the side surface of the pin-type component on one side of the inspection stage. The vision camera module may continuously capture the images of the side surface of the pin-type component while the pin-type component is rotating. Alternatively, the pin-type component may be rotated by a predetermined angle at a time, and the vision camera module may capture an image of the surface of the pin-type component while the pin-type component is temporarily stopped.

In addition, Step S400 may be performed in a state where light from the lighting module is irradiated onto the surface of the pin-type component. In this case, the lighting module may be provided as a coaxial lighting module for the vision camera module so that light can be irradiated onto a portion of the surface of the pin-type component where the vision camera module focuses on.

In Step S500 where the defect inspection on the pin-type component is performed, the images obtained by capturing the surface of the pin-type component may be used in the defect inspection on the pin-type component. In this case, a program for detecting a predefined defect within the images has already been disclosed in the prior art, so a description thereof will be omitted. Step S500 may be performed by the information processing device that receives and processes the captured image into a required format.

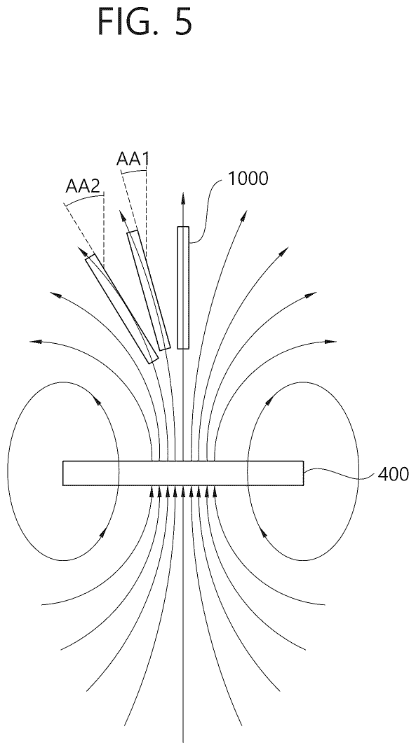

Referring to FIG. 5, the vision inspection method for pin-type component according to an embodiment of the disclosure uses the magnet 400 to correct the posture of the pin-type component 1000 will be described. FIG. 5 is a diagram for illustrating the principle of adjusting a pin-type component by using a magnet according to the disclosure. According to an embodiment of the disclosure, the magnet 400 may be shaped like a disc. The pin-type component 1000 may receive a magnetic force in different directions depending on its position relative to the center of the magnet 400.

At the center of the magnet 400, magnetic field lines may appear generally in the vertical direction. As the distance from the center of the magnet increases, the inclination AA1, AA2 of the magnetic field lines may become greater. Therefore, by adjusting the relative position between the center of the magnet 400 and the pin-type component 1000 to change the direction of the magnetic field lines acting on the pin-type component 1000, the posture (angle) of the pin-type component 1000 can be adjusted in a non-contact manner.

In this case, in order for the pin-type component 1000 to have the correct upright posture, the central axis of the magnet 400 and the central axis of the pin-type component 1000 need to be coaxially positioned. Therefore, in Step S300 where the pin-type component are corrected to the upright posture, the magnet driving unit for moving the magnet 400 may move the magnet 400 so that the central axis of the magnet 400 becomes coaxial with the central axis of the pin-type component 1000. In this case, the information processing device or an equivalent control device may control the magnet driving unit by a proportional integral (PI) control method so that the magnet 400 can be positioned as described above. Meanwhile, in the aforementioned non-contact alignment device, the magnet driving unit corresponds to the position adjustment unit.

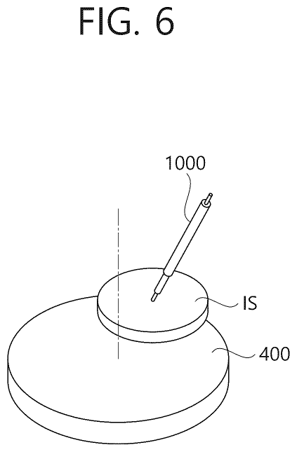

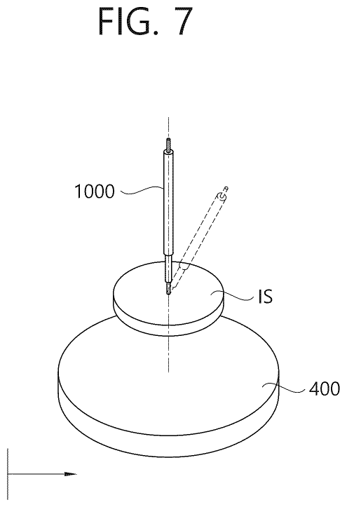

Hereinafter, it will be described with reference to FIGS. 6 and 7 that the magnet 400 moves relative to the inspection stage IS in Step S300 in which the pin-type component is corrected to the upright posture according to an embodiment of the disclosure. FIG. 6 is a view showing a state in which the pin-type component is placed on the inspection stage in a tilted posture. In this regard, FIG. 7 is a view showing a state in which the pin-type component is corrected to the upright posture based on the movement of the magnet.

As shown in FIG. 6, the pin-type component 1000 may initially be seated on the inspection stage IS mostly in the tilted posture. In this case, the posture of the pin-type component 1000 may be the same as or similar to the initially seated posture even after the inspection stage IS is moved so that the lower end of the pin-type component 1000 can be placed on the rotation axis due to the frictional force of the inspection stage IS or the magnetic force of the magnet 400. In this case, the tilted posture may refer to a posture in which the angle between the inspection stage IS and the pin-type component 1000 is not a right angle.

Meanwhile, the magnet 400 may be moved by the PI-controlled magnet driving unit so as to be positioned directly below the contact point between the pin-type component 1000 and the inspection stage IS as shown in FIG. 7. In this state, the magnetic field lines generated by the magnet 400 are oriented in the vertical direction, and thus the pin-type component 1000 is corrected to the upright posture.

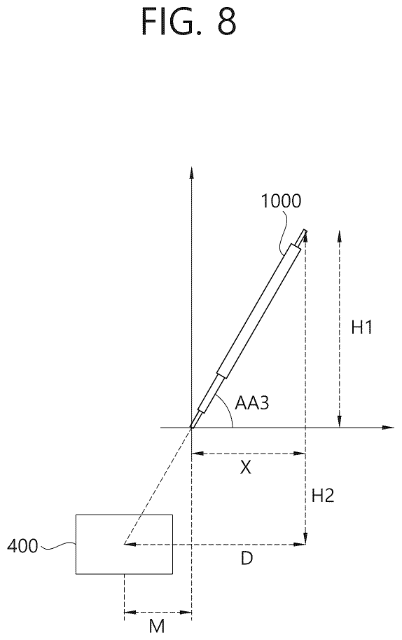

Hereinafter, it will be described with reference to FIG. 8 how to determine the distance by which the information processing device moves the magnet in the horizontal direction. FIG. 8 is a diagram for illustrating how to determine a horizontal movement distance of a magnet according to an embodiment of the disclosure. As described above, in order for the pin-type component 1000 to be corrected to the upright posture, the center of the magnet 400 needs to be positioned directly below the contact point between the pin-type component 1000 and the inspection stage. In this state, the central axis of the magnet 400 and the central axis of the pin-type component 1000 are positioned coaxially with each other.

In order to move the magnet 400 as described above, the information processing device calculates a distance M by which the magnet 400 will be horizontally moved to be positioned directly below the pin-type component 1000.

In this case, the movement distance M may be calculated by the equation M=KX, where K is a proportional constant obtained experimentally, and X is the length of the pin-type component 1000 projected on the upper surface of the inspection stage and also denoted as X in FIG. 8. In this case, the information processing device previously stores the length of the pin-type component 1000, and calculates X based on the previously stored length and the angle AA3 between the inspection stage and the pin-type component 1000. More specifically, the information processing device may calculate X by multiplying the length of the pin-type component 1000 by the cosine of angle AA3.

Meanwhile, the angle AA3 may be calculated through the following process.

First, in Step S300 where the pin-type component is corrected to the upright posture, the backlight module facing the vision camera module with the inspection stage therebetween may be turned on before correcting the posture. The front surface of the backlight module may be large enough to form a background for the pin-type component 1000 when captured by the vision camera module, and light may be irradiated from the front surface. Hereinafter, an image of the pin-type component 1000 captured by the vision camera module while the backlight module is irradiating light will be referred to as a posture check image.

In the posture check image, the pin-type component 1000 appears very dark against the background due to the backlighting from the backlight module. Therefore, a boundary between the background and the pin-type component 1000 is very clear, which is the feature of the posture check image. The information processing device identifies the boundary of the pin-type component 1000 in the posture check image, and calculates the central coordinates of the boundary, thereby determining the central axis of the pin-type component 1000. Once the central axis of the pin-type component 1000 is determined, the information processing device may calculate the angle AA3 of the central axis of the pin-type component 1000 with respect to the inspection stage in the posture check image.

Thereafter, the information processing device may calculate the movement distance M based on the identified angle AA3, the pre-stored length, and the pre-stored proportional constant K. In this case, the basis for calculating the movement distance M as the product of K and X is as follows.

Specifically, the movement distance M corresponds to the difference between a horizontal straight-line distance D from the center of the magnet 400 to the top of the pin-type component 1000 and the projected length X of the pin-type component 1000. In other words, M is equal to a value obtained by subtracting X from D.

Furthermore, based on the property of triangle similarity, a ratio of X to D is equal to a ratio of the height H1 of the pin-type component 1000 in the tilted posture to the height difference H2 between the top of the pin-type component 1000 and the center of the magnet 400. In other words, the ratio of X to D is equal to the ratio of H1 to H2. Therefore, X may be expressed as a value obtained by multiplying D by a predetermined constant. Using this property, the equation for M may be expressed as the product of an appropriate constant K and X. In this case, K is obtained experimentally. By conducting an experiment after appropriately setting the range of angle AA3 at which the pin-type component 1000 is generally placed on the inspection stage, it is possible to secure a more appropriate K.

Meanwhile, in Step S300 where the pin-type component is corrected to the upright posture, the posture check image may be captured again after repositioning the magnet, thereby verifying whether the pin-type component 1000 is properly corrected to the upright posture. When the pin-type component 1000 is properly corrected to the upright posture, the information processing device may turn off the backlight module and control the rotation driving unit to rotate the inspection stage. In this case, the proper correction to the upright posture may be verified based on whether the angle of the central axis of the pin-type component 1000 in the posture check image is within a predetermined range centered on the vertical direction.

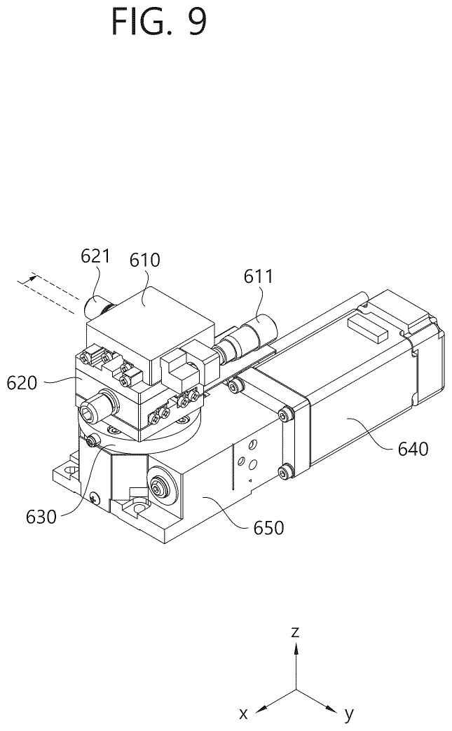

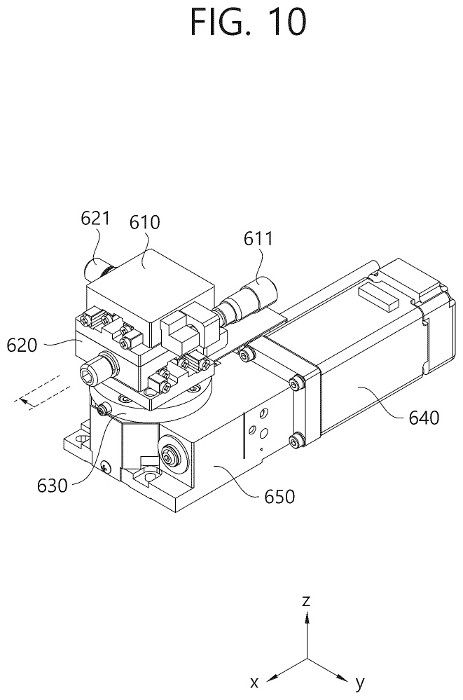

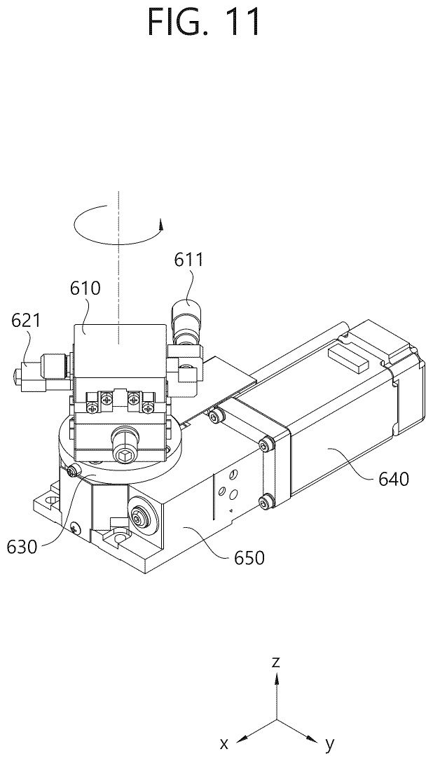

Below, an example that the inspection stage moves to position the pin-type component on the rotation axis will be described with reference to FIGS. 9 to 11. FIG. 9 is a view showing the adjustment of an X-axis error of the inspection stage by the non-contact alignment device according to an embodiment of the disclosure. In this regard, FIG. 10 is a view showing the adjustment of a Y-axis error of the inspection stage by the non-contact alignment device according to an embodiment of the disclosure. Further, FIG. 11 is a view showing the operation of the rotation driving unit of the non-contact alignment device according to an embodiment of the disclosure.

In this case, FIGS. 9 and 10 show an example in which the X-axis error is adjusted first and then the Y-axis error is adjusted, but the reverse may also be possible. Further, the X-axis and/or Y-axis error is adjusted as shown in FIGS. 9 and 10, and then the posture of the pin-type component may first be corrected by the magnet before the rotation driving unit rotates as shown in FIG. 11.

When the posture of the pin-type component is corrected after moving along the X-axis or Y-axis, the information processing device moves the inspection stage in the X-axis or Y-axis direction so that the central axis of the pin-type component and the rotation axis of the rotation driving unit can become coaxial, thereby positioning the contact point of the pin-type component on the rotation axis.

For example, the information processing device may determine the X-axis and Y-axis displacements based on the X-axis and Y-axis displacement images described above. Because the description in this regard has been made above, redundancy will be omitted. As another example, the information processing device may determine a position adjustment amount for the inspection stage based on a top-view image captured by the vision camera module disposed above the inspection stage. Specifically, the information processing device first identifies the X and Y coordinates at which the contact point of the pin-type component is located on the top-view image, and calculates the displacements for the first frame 610 and the second frame 620 to position the pin-type component on the rotation axis of the rotation driving unit 640. In this case, the position of the rotation axis of the rotation driving unit 640 is always fixed, the X and Y coordinates of the rotation axis on the position check image or the top-view image may be accurately measured and previously stored in the information processing device.

Once the alignment between the rotation driving unit 640 and the pin-type component is completed and the posture of the pin-type component is corrected, the third frame 630 is rotated as shown in FIG. 11 to initiate capturing images of the side surface of the pin-type component.

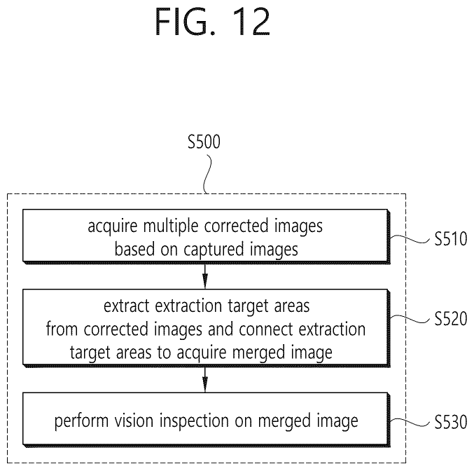

Below, operations involved in Step S500 in which the defect inspection on the pin-type component according to an embodiment of the disclosure is performed will be described with reference to FIG. 12. FIG. 12 is a flowchart of performing defect inspection on the pin-type component according to an embodiment of the disclosure.

As shown in FIG. 12, Step S500 in which the defect inspection on the pin-type component is performed according to an embodiment of the disclosure may include steps of acquiring a plurality of corrected images based on captured images (S510), extracting extraction target areas from the corrected images and acquiring a merged image in which the extraction target areas are connected to each other (S520), and performing vision inspection on the merged image (S530).

In Step S510 where the plurality of the corrected images are acquired based on the captured images, the corrected images in which the pin-type component shown in the captured images is changed to predetermined postures may be acquired. The corrected image may be acquired for each captured image. In this case, the captured images may correspond to different rotation angles of the pin-type component. Meanwhile, the predetermined postures may include a posture in which the pin-type component is exactly vertical relative to the inspection stage.

Although the magnet changes the pin-type component as close as possible to the upright posture in the previous step, it is practically difficult to make the pin-type component be perfectly perpendicular to the inspection stage. In Step S510, the corrected image in which the pin-type component is in the exactly upright posture is acquired by rotating the pin-type component appearing in the captured image through image processing of the information processing device.

In Step S520 where the extraction target areas are extracted from the corrected images and the merged image in which the extraction target areas are connected is acquired, a portion of the pin-type component may be extracted as the extraction target area within the corrected image. In this case, that portion may be a middle portion of the vertically erected pin-type component appearing in the image, which may be a portion where lighting is concentrated during the capturing process.

The merged image may be an image formed by sequentially connecting the extraction target areas extracted from different captured images. For example, the information processing device may obtain a single merged image by connecting the extraction target areas according to the capturing sequence of the captured images that serves as the basis for the extraction. In the merged image formed in this way, each extraction target area may be positioned corresponding to the actual position of the pin-type component, and the merged image may be obtained as an unfolded view of the side surface of the pin-type component.

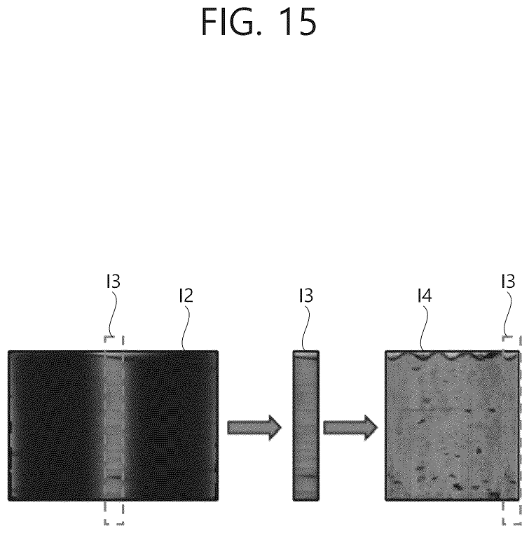

Meanwhile, the extraction target area may be identified based on the difference in pixel values between the pin-type component and the background in the corrected image, which is caused by light from the lighting module. In this regard, description will be made later with reference to FIG. 15.

Meanwhile, in Step S530 where the vision inspection on the merged image is performed, defects appearing in the merged image may be identified by the information processing device. Defects may be preset as defects that should not be present on the appearance of the pin-type component, such as foreign substances, scratches, and dents. To this end, the information processing device may previously store an algorithm or program that determines the presence and type of defects based on the pixel values of each pixel in the merged image and the patterns appearing in the merged image.

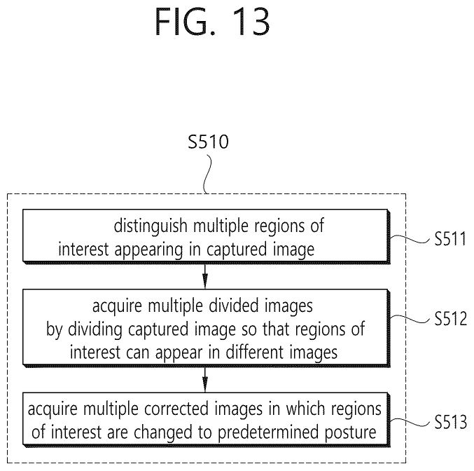

Below, operations involved in Step S510 in which a plurality of corrected images is acquired based on captured images will be described with reference to FIG. 13. FIG. 13 is a flowchart of acquiring a plurality of corrected images based on captured images according to an embodiment of the disclosure.

As shown in FIG. 13, Step S510 of acquiring a plurality of corrected images based on the captured images according to an embodiment of the disclosure may include steps of distinguishing a plurality of regions of interest appearing in the captured image (S511), acquiring a plurality of divided images by dividing the captured image so that the regions of interest can appear in different images (S512), and acquiring a plurality of corrected images in which the regions of interest are changed to predetermined postures (S513).

In Step S511 where the plurality of regions of interest appearing in the captured image is distinguished, the plurality of regions of interest may be recognized and distinguished in a single captured image. Referring beck to FIG. 1, the regions of interest may be set as a lower portion 1001, a middle portion 1002, and an upper portion 1003. The information processing device may be configured to distinguish these portions based on the shape characteristics of the lower portion 1001, the middle portion 1002, and the upper portion 1003 appearing in the captured image.

For example, the information processing device may first recognize pixels located along the boundary of the pin-type component appearing in the captured image, and calculate the midpoint coordinates between the pixels located at both end boundaries to determine the central axis of the pin-type component. Then, the information processing device may identify points, at which pixel distances between the central axis and the pixels located at the boundaries changes suddenly, as the boundaries of the regions of interest, thereby distinguishing the lower portion 1001, the middle portion 1002, and the upper portion 1003 in the captured image. In this case, the pixel distance may be determined, for two pixels, as a distance calculated based on the coordinate values of the pixels or as the number of pixels located between the two pixels.

Alternatively, as another example, the captured image is acquired after the pin-type component are roughly corrected to the upright posture, and thus the information processing device may previously store information about portions where the regions of interest appear in the captured image. For example, the coordinate ranges, in which the regions of the upper portion 1003, the middle portion 1002, and the lower portion 1001 appear in the captured image, are recorded in advance in the information processing device, and the information processing device may distinguish the regions based on the pre-recorded coordinate ranges. In this case, the coordinate ranges may be, for example, coordinate ranges with respect to the vertical axis on the image.

In Step S512 where the plurality of divided images are acquired by dividing the captured image so that the regions of interest appear on different images, a new divided image may be formed for each region of interest distinguished in the previous step. The plurality of divided images may be acquired by cutting the boundaries of the regions of interest on the captured image. Therefore, based on the foregoing example, one captured image is divided into a divided image for the upper portion 1003, a divided image for the middle portion 1002, and a divided image for the lower portion 1003.

In Step S513 where the plurality of corrected images with the regions of interest changed to predetermined posture are acquired, each divided image is processed to change the region of interest shown in the divided image to a predetermined posture. After this step, the plurality of corrected images, in which the regions of interest are represented in the vertical posture, are acquired for the respective regions of interest.

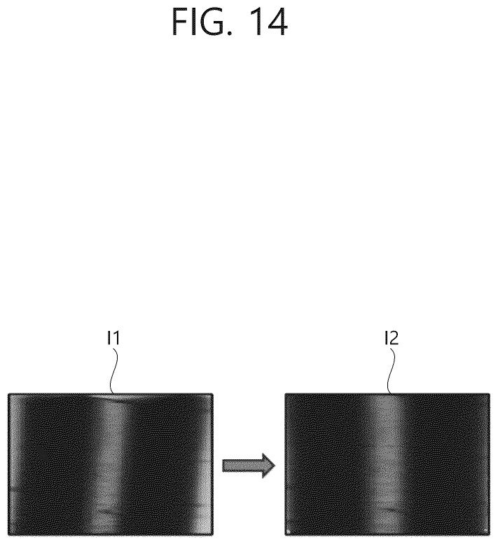

The description will be continued with reference to FIG. 14, in which FIG. 14 is a view showing the acquisition of a corrected image based on any one of divided images.

In FIG. 14, the region of interest (the bright portion in the middle of the image) shown in the divided image I1 may initially be slightly tilted. For example, as described above, the information processing device may identify the central axis of the region of interest based on the pixels located at the boundary of the region of interest, and then process the image so that the central axis becomes vertical, thereby acquiring the corrected image I2.

The description will be continued with reference to FIG. 15, in which FIG. 15 is a view showing the identification of an extraction target area in the corrected image of FIG. 14, and the formation of a merged image based on the extraction target area.

The information processing device may first identify the central axis of the region of interest shown in the corrected image I2. Then, the information processing device may set an extraction target area I3 based on a set of pixels located within a predetermined pixel distance in the horizontal direction from the central axis. The images for the extraction target area I3 extracted in this way are sequentially arranged and connected according to the capturing order, thereby acquiring one merged image I4. Accordingly, the merged image I4 may be an image in which the region of interest of the pin-type component is cut in the height direction and then unfolded.

Meanwhile, after forming the divided images according to an embodiment, defect detection for the regions of interest may be implemented by different information processing devices. For example, a plurality of different information processing devices may receive the divided images for different regions of interest, process the divided images independently of one another to obtain the corrected images, form a merged image, and then ultimately detect a defect in the merged image. In this case, the computational burden on a single information processing unit is reduced, enabling rapid inspection of pin-type component. However, this is merely an example, and it is also possible for a single information processing unit to perform all the steps.

A person having ordinary knowledge in the art to which the disclosure pertains can understand that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

According to the embodiments of the disclosure, the effects are at least as follows.

The inspection efficiency of the pogo pin can be maximized.

The effects of the disclosure are not limited to those described above, and various other effects are included in the foregoing description.

### REFERENCE NUMERALS

1: non-contact alignment device
100: seating unit
110: seating surface
200: recognition unit
300: body unit
400: magnet
500: position adjustment unit
600: position alignment unit
610: first frame
620: second frame
630: third frame
640: rotation driving unit
650: base
1000: pogo pin/pin-type components
1001: lower portion
1002: middle portion
1003: upper portion
IS: inspection stage
I1: divided image
I2: corrected image
I3: extraction target area
I4: merged image

What is claimed is:

1. A vision inspection method for pin-type component, comprising:
seating a pin-type component on an upper surface of an inspection stage in a tilted posture;
correcting the pin-type component to an upright posture based on a magnet;
capturing an image of a surface of the pin-type component while rotating the pin-type component; and
performing defect inspection on the pin-type component based on a plurality of captured images acquired by capturing the surface of the pin-type component.

2. The vision inspection method of claim 1, wherein, in the correcting the pin-type component to the upright posture, the magnet moves relative to the pin-type component so that the pin-type component can be corrected to the upright posture.

3. The vision inspection method of claim 2, wherein, in the correcting the pin-type component to the upright posture, a magnet driving unit is controlled by a proportional integral (PI) control method to move the magnet so that a central axis of the magnet and a central axis of the pin-type component can become coaxial.

4. The vision inspection method of claim 2, wherein, in the correcting the pin-type component to the upright posture, a distance M to move the magnet located below the inspection stage toward the pin-type component in a horizontal direction is calculated by an equation M=KX, where K is a proportional constant obtained experimentally, and X is the length of the pin-type component projected on the upper surface of the inspection stage.

5. The vision inspection method of claim 1, further comprising, before the capturing the image of the surface of the pin-type component, adjusting a position of the inspection stage relative to a rotation driving unit so that a lower portion of the pin-type component can be positioned on a rotation axis of the rotation driving unit which rotates the inspection stage.

6. The vision inspection method of claim 1, wherein the performing the defect inspection comprises:
acquiring a plurality of corrected images in which the pin-type component shown in the captured images is changed to predetermined posture;
acquiring a merged image by extracting extraction target areas, in which a portion of the pin-type component appears, from the corrected images, and connecting the plurality of extraction target areas; and
performing a vision inspection on the merged image.

7. The vision inspection method of claim 6, wherein, in the capturing the image of the surface of the pin-type component, the surface of the pin-type component is captured while a lighting module is irradiating light to the pin-type component.

8. The vision inspection method of claim 7, wherein, in the acquiring the merged image, the extraction target area is identified based on difference in pixel values between the surface of the pin-type component and the background in the corrected image, which is caused by light from the lighting module.

9. The vision inspection method of claim 6, wherein the acquiring the corrected image comprises:
distinguishing a plurality of regions of interest for the pin-type component appearing in the captured images;
acquiring a plurality of divided images by dividing the captured images so that the plurality of regions of interest can appear in different images; and
acquiring plurality of the corrected images in which the regions of interest appearing in the divided images are changed to the predetermined posture.

10. The vision inspection method of claim 6, wherein, in the acquiring the merged image, the merged image is acquired as the plurality of extraction target areas are sequentially connected corresponding to actual positions of the pin-type component.

11. The vision inspection method of claim 9, wherein, in the acquiring the corrected image, the predetermined posture is a posture in which the pin-type component is captured upon being exactly vertical relative to the inspection stage.
